(19) United States
(12) Patent Application Publication
(10) Pub. No.: US 2009/0220656 A1
(43) Pub. Date: Sep. 3, 2009

(54) APPARATUS AND METHOD FOR PRODUCING CENTER-FILLED CONFECTIONERY PRODUCTS

(75) Inventors: Juan Fabre, Barcelona (ES); Pedro Michelena, Barcelona (ES); Luis Bordera, Barcelona (ES); Juan Jose Del Rio, Zaragoza (ES); Albert Xambo, Sabadell (ES)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/299,221

(22) PCT Filed: Apr. 30, 2007
(86) PCT No.: PCT/US2007/067803

§ 371 Date: May 4, 2009

Related U.S. Application Data
(60) Provisional application No. 60/746,120, filed on May 1, 2006.

(51) Int. Cl. A23G 3/20; A23G 3/02; A23G 3/32

(52) U.S. Cl. 426/272; 425/113; 425/145; 425/302.1; 426/518; 425/112; 426/512; 426/516; 426/281; 426/279; 426/273; 426/517

(57) ABSTRACT

The present disclosure provides an apparatus and method for the production of center-filled confectionery pieces. The apparatus includes an extruder, a feedback system, and a forming device. The feedback system ensures that a strand of center-filled confectionery produced by the extruder has a substantially uniform size when the strand enters the forming device. The forming device forms the strand into center-filled confectionery pieces having 15%-25% by weight of a center-fill material without producing leakers.

### BACKGROUND

The present disclosure relates generally to confectionery products and apparatuses and methods for making the same

In the confectionery art, it is desirable to maximize the amount of fill material present in a center-filled confectionery product. Fill material, typically a fluid or a liquid such as a syrup, is capable of delivering proportionally greater amounts of flavor and/or sweetener when compared to confectionery substrates commonly used to encase the fill material. Thus, increasing the amount of fill material in the confectionery product correspondingly increases consumer enjoyment of the product.

### SUMMARY

The present disclosure provides an apparatus and method for the production of center-filled confectionery pieces with large amounts of center-fill material and substantially little or no risk of forming pieces having fill material leaking therefrom.

In an embodiment, an apparatus for producing a confectionery product is provided. The apparatus includes an extruder for extruding a confectionery and a sensor device for detecting a property of the confectionery. The sensor device is in operative communication with an extruder screw of the extruder. The sensor device causes an adjustment of the rotation rate of the extruder screw based on the detected property. The adjustment of the extruder screw rotation rate produces a confectionery having a substantially uniform diameter along substantially an entire length thereof.

The sensor device may be a light emitter/receiver, a weighing device, a flowmeter and combinations thereof. The sensor device is capable of detecting one or more of the following properties a diameter of the confectionery, a weight of the confectionery, a flow rate of the confectionery, and combinations thereof.

In an embodiment, another apparatus for producing a confectionery product is provided. The apparatus includes an extruder for extruding a center-filled confectionery and a sensor device for detecting a property of the center-filled confectionery. The center-filled confectionery has an outer portion of a confectionery material and a center portion of a fill material. The sensor device is in operative communication with a confectionery flow regulation device and a fill material flow regulation device. Based on the detected property, the extruder causes an adjustment of one or both of the following: the confectionery flow rate and/or the center fill material flow rate. The center-filled confectionery has a substantially uniform diameter along substantially an entire length thereof.

In an embodiment, the sensor device may be any sensor device as previously identified above. The sensor device is capable of sensing one or more of the following properties of the center-filled confectionery: a diameter of the confectionery, a weight of the confectionery, a flow rate of the center-filled confectionery, a flow rate of the outer confectionery material, and a flow rate of the center fill material.

In an embodiment, the apparatus includes a pre-extruder for delivering a confectionery extrudate to the extruder. A second sensor device senses a second property of the confectionery extrudate. The second sensor device is in operative communication with the pre-extruder. The pre-extruder adjusts an extrusion flow rate of the confectionery extrudate in response to the detected second property. The second sensor device may be a light emitter/receiver, a weighing device, a flowmeter and any combination thereof. The second property may be one or more of the following: a diameter of the extrudate, a weight of the extrudate, a flow rate of the extrudate.

In an embodiment, the confectionery extrudate has a substantially uniform diameter along substantially an entire length thereof. In particular, the confectionery extrudate has a substantially uniform diameter along substantially the entire length thereof when the confectionery extrudate enters the extruder.

In an embodiment, the apparatus includes a forming device for forming a plurality of sealed center-filled confectionery pieces when the center-filled confectionery passes therethrough. The forming device may be one or more of the following: a rotoplast forming device, a chain drive forming device, a drum drive forming device, and a forming device which includes pair of parallel rollers.

In an embodiment, a method for producing a confectionery product is provided. The method includes extruding a confectionery with an extruder which has an extruder screw. The method includes detecting a property of the confectionery, and adjusting the rotation rate of the extruder screw based on the detected property. The method may include detecting one or more of the following properties of the confectionery: a diameter of the confectionery, a weight of the confectionery, and a flow rate of the confectionery.

In an embodiment, the method includes forming a confectionery having a substantially uniform diameter along substantially an entire length thereof.

In an embodiment, another method for producing a confectionery product is provided. The method includes extruding a center-filled confectionery, detecting a property of the center-filled confectionery. The center filled confectionery has an outer portion of a confectionery and a center portion of a fill material. The method further includes adjusting a flow rate based on the detected property. The flow rate may be the flow rate of the confectionery flow rate or the flow rate of the center fill material. In an embodiment, both the confectionery flow rate and the fill material flow rate may be adjusted based on the detected property.

In an embodiment, the method includes forming a center-filled confectionery having a substantially uniform diameter along substantially an entire length thereof.

In an embodiment, the method includes detecting one or more of the following properties: a diameter of the center-filled confectionery, a weight of the center-filled confectionery, a flow rate of the center-filled confectionery material, a flow rate of the outer confectionery material, and a flow rate of the center-fill material.

In an embodiment, the method includes forming a plurality of sealed center-filled confectionery pieces from the center-filled confectionery.

In an embodiment, the method includes cutting the center-filled confectionery into a sealed center-filled confectionery segment before forming the center-filled confectionery into a plurality of sealed center-filled confectionery pieces.

In an embodiment, the method includes extruding a confectionery extrudate. The confectionery extrudate is extruded from a pre-extruder. The method further includes detecting a second property of the confectionery extrudate, adjusting the extruding in response to the second property, and forming, with the confectionery extrudate, the outer confectionery portion of the center-filled confectionery. In an embodiment, the method includes forming the confectionery extrudate to have a substantially uniform diameter along substantially an entire length thereof.

In an embodiment, the method includes detecting one or more of the following properties: a diameter of the confectionery extrudate, a weight of the confectionery extrudate, and a flow rate of the confectionery extrudate.

In an embodiment, a cutting device is provided. The cutting device includes a rotating member with a contact portion. The contact portion has a cutting edge located between a first contact surface and a second contact surface. The rotating member is constructed and arranged such that when it is rotated, the contact portion contacts a flexible structure to be cut, the contact portion producing a flat portion on the flexible structure, and the cutting edge cuts the flat portion. The flexible structure may be a confectionery or a center-filled confectionery.

In an embodiment, the cutting device includes a dispenser for applying an adhesion reducer to either one or both of the flexible structure and/or the contact portion.

In an embodiment, the cutting device includes a second rotating member. The second rotating member has a second contact portion with a second cutting edge. The rotating member is located on a first side of the flexible structure and the second rotating member located on an opposing second side of the flexible structure. The contact portions of each rotating member cooperatively contact the flexible structure to cut the flexible structure on the flat portion.

In an embodiment, the contact portion and the second contact portion form respective first and second flat portions on opposing sides of the flexible structure. The first and second flat portions are substantially coextensive.

In an embodiment, a method for cutting a confectionery is provided. The method includes moving a confectionery adjacent to a rotating member with a contact portion. The contact portion has a first contact surface and a second contact surface and a cutting edge therebetween. The method includes contacting the confectionery with the contact portion to form a flat portion on the confectionery, and cutting the flat portion with the cutting edge.

In an embodiment, the confectionery may be a center-filled confectionery. The method further includes sealing at least one end of the center-filled confectionery and forming a sealed center-filled confectionery segment. The center-filled confectionery may include a center fill material. The method may include removing the center-fill material from the at least one end prior to the sealing.

In an embodiment, the method includes contacting the first contact surface with the confectionery before the cutting. The method may also include contacting the second contact surface with the confectionery after the cutting.

In an embodiment, the method includes feeding the confectionery between the rotating member and a second rotating member with a second contact portion and a second cutting edge, rotating the rotating members to bring the first and second cutting edges in cooperative engagement with each other, and cutting the confectionery from opposing sides.

In an embodiment, the method includes forming first and second flat portions on opposing sides of the confectionery.

In an embodiment, a forming device for forming a confectionery product is provided. The forming device includes a first rotatable roller parallel to a second rotatable roller. Each roller has a plurality of spaced apart protruding edges with a piece length between each protruding edge. An end length is present between a protruding endmost edge and an end of the rollers. The end length is greater than the piece length.

In an embodiment, each roller includes a second end length between a second protruding endmost edge and a second end of the rollers. The second end length is greater than the piece length.

In an embodiment, the first roller is moveable towards and away from the second roller. Each roller may also include an arcuate shaping surface between the protruding edges.

In an embodiment, the rollers are rotatable to cooperatively engage the protruding edges of the first roller with the protruding edges of the second roller. Cooperative engagement between opposing protruding edges forms a plurality of sealed center-filled confectionery pieces when a center-filled confectionery segment parallel to the rollers passes between the first and second rollers. The forming device may include a separating device for separating a sealed center-filled confectionery piece having a piece length from a sealed center-filled confectionery piece having an end length.

In an embodiment, the forming device includes a shaping device for forming the sealed center-filled confectionery piece having the piece length into a shape such as spheroidal, spherical, substantially spherical, elliptical, egg-shaped, and combinations thereof.

In an embodiment, a method for producing a confectionery product is provided. The method includes providing a first rotatable roller parallel to a second rotatable roller. Each roller has a plurality of spaced apart protruding edges with a piece length between each protruding edge. The method includes removing a protruding edge from an end of each roller to produce an end length between a protruding endmost edge and the end of each roller. The end length is greater than the piece length. The method further includes placing a sealed center-filled confectionery segment between the first and second rollers, and rotating the rollers to cooperatively engage the protruding edges to form a sealed center filled confectionery piece having an end length and at least one sealed center filled confectionery piece having a piece length.

In an embodiment, the method includes forming the sealed center-filled confectionery piece having the piece length to contain from about 15% to about 25% by weight of a center-fill material. The method may also include forming the sealed center-filled confectionery piece having the piece length to have a weight from about 6 g to about 9 g.

In an embodiment, another method for producing a confectionery product is provided. The method includes placing a sealed center-filled confectionery segment between a first roller that is parallel to a second roller. Each roller has a protruding endmost edge. The method includes rotating the rollers to cooperatively engage the protruding edges and forming with the protruding endmost edges a sealed center-filled confectionery endmost piece.

In an embodiment, the sealed center-filled confectionery segment has opposing ends. The method includes sealing the ends before placing the sealed center-filled confectionery segment between the rollers.

In an embodiment, the method includes moving the first roller toward the second roller during the forming.

In an embodiment, each roller includes a first protruding endmost edge at a first roller end and a second protruding endmost edge at a second roller end. The method includes cooperatively engaging the first protruding endmost edges and the second protruding endmost edges and forming respective first and second sealed center-filled confectionery endmost pieces.

In an embodiment, another method for forming a confectionery product is provided. The method includes placing a sealed center-filled confectionery segment between a first roller that is parallel to a second roller. Each roller has a protruding endmost edge spaced from a protruding inner edge. The method includes rotating the rollers to cooperatively engage the protruding edges, and forming a sealed center-filled confectionery endmost piece and a sealed center-filled confectionery piece, the sealed center-filled confectionery endmost piece having a length greater than the length of the sealed center-filled confectionery piece.

In an embodiment, the method includes separating the sealed center-filled endmost piece from the sealed center-filled confectionery piece. The sealed center-filled confectionery pieces is then shaped into a shape such as rounded, spherical, substantially spherical, elliptical, egg-shaped and any combination thereof.

In an embodiment, the method includes forming the sealed center-filled confectionery piece to contain from about 15% to about 25% by weight of a center-fill material. The method may also include forming the sealed center-filled confectionery piece to have a weight from about 6 g to about 9 g.

In an embodiment, the method includes forming a leak-free sealed center-filled confectionery piece. The method may also include forming a leak-free sealed center-filled confectionery endmost piece.

In an embodiment, another apparatus for forming a confectionery product is provided. The apparatus includes a cutting device at a proximate end of a forming device. A detection device is located at a distal end of the forming device. The detection device is in operative communication with the cutting device. The detection device directs the cutting device to cut a center filled confectionery into a sealed center filled confectionery segment when the detection device detects the presence of a leading end of the confectionery.

In an embodiment, the apparatus includes a transport device for moving the center filled confectionery from the cutting device to the detection device.

In an embodiment, the forming device receives the sealed center filled confectionery segment and forms a plurality of sealed center filled confectionery pieces. The forming device includes a pair of parallel rollers. The pair of parallel rollers has a plurality of cooperating protruding edges spaced apart along a length of the rollers. The pair of parallel rollers has a proximate end portion and a distal end portion, and the leading end passes between the distal end portion. A trailing end of the sealed confectionery segment passes through the proximate end portion.

In an embodiment, a controller is in operative communication with the detection device, the cutting device and the transport device. The controller halts the transport device upon detection of the leading end. The controller may direct the cutting device to cut the strand after the transport device is halted.

In an embodiment, another method for producing a confectionery product is provided. The method includes moving a leading end of a confectionery to a distal end of a forming device and detecting the presence of the leading end at the distal end. The detecting occurs by way of a detection device. The method includes cutting the confectionery with a cutting device located at a proximate end of the forming device upon detection of the leading edge. The method may include halting the movement of the confectionery upon occurrence of the detecting. The cutting may occur after the confectionery is halted.

In an embodiment, the confectionery is a center-filled confectionery. The method includes forming a sealed center-filled confectionery segment, placing the sealed center-filled confectionery segment into the forming device, and forming a plurality of leak-free sealed center-filled confectionery pieces from the sealed center-filled confectionery segment.

It is an advantage of the present disclosure to provide an improved method for making chewing gum.

It is an advantage of the present disclosure to provide an improved chewing gum.

It is an advantage of the present disclosure produce a center-filled confectionery product with a large proportion of center-fill material such as a flavored syrup.

It is an advantage of the present disclosure to provide an apparatus and production process which reduces, or wholly eliminates, the risk of forming leakers during the center-filled piece forming stage.

It is an advantage of the present disclosure to provide an apparatus and production process that increases product output and reduces production downtime.

Additional features and advantages are described herein, and will be apparent from, the following Detailed Description and the figures.

### BRIEF DESCRIPTION OF THE FIGURES

FIG. 1 is a schematic representation of an apparatus for producing center-filled confectionery products in accordance with the present disclosure.

FIG. 2 is a perspective view of sizing rollers and a cutting device in accordance with an embodiment of the present disclosure.

FIG. 3 is a schematic representation of the sizing rollers.

FIGS. 4A, 4B, and 4C are each a sectional view of a cutting device cutting a confectionery material in accordance with an embodiment of the present disclosure.

FIGS. 5A and 5B, are each a perspective view of a forming device.

FIG. 5C is a sectional view taken along line 5C-5C of FIG. 5B.

FIGS. 6A and 6B, are each a perspective view of a forming device in an accordance with an embodiment of the present disclosure.

FIG. 6C is a sectional view taken along line 6C-6C of FIG. 6B.

FIG. 7 is a partially-cut away perspective view of a sealed center-filled confectionery product in accordance with an embodiment of the present disclosure.

### DETAILED DESCRIPTION

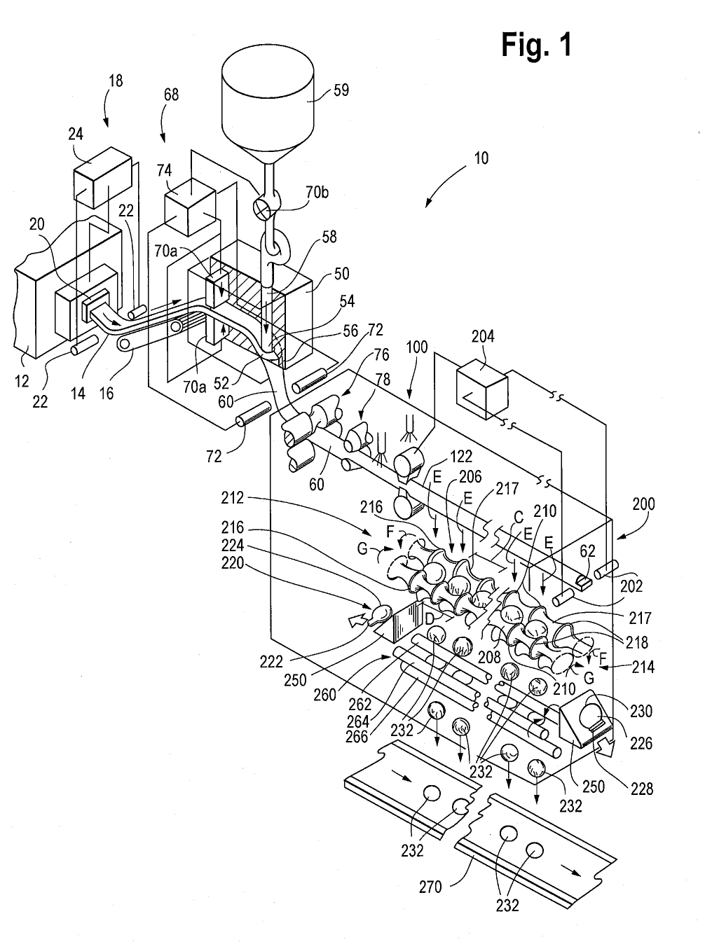

Referring to the Figures generally and in particular to FIG. 1, an apparatus 10 for producing center-filled confectionery is shown. Apparatus 10 includes a pre-extruder 12, an extruder 50, a cutting device 100, and a forming device 200, each of which will be discussed in detail. Pre-extruder 12 receives confectionery material from a source of confectionery material (not shown) such as a mixer or hopper, for example. The confectionery material may be any hard candy, soft candy, chewing gum, or other confectionery substance, or compound that has a fluid phase or may take a fluid form. In other words, the confectionery material may be heated or melted, form a syrup, or be dissolved in a liquid to become flowable or fluid as is commonly known in the art. The moisture content (and concomitant viscosity) of the confectionery material may vary greatly. The moisture content of the flowable phase of the confectionery substrate may typically be in the range of about 0.5% to about 20% by weight of the confectionery material. The fluid confectionery material may be subsequently cooled or solidified at room temperature to form a solid or semi-solid confectionery. Nonlimiting examples of suitable confectionery materials that are fluid or may placed into a fluid state include pastes, gels, syrups, liquids or solids for making hard candies, soft candies, lollipops, fondants, toffees, jellies, chewing gums, chocolates, gelatins and nougats. The fluid confectionery material may include sugar or may be sugar-free. Coloring may be added to the fluid confectionery material as desired. The confectionery material may also include a pharmaceutical product or a medicament. In an embodiment, the confectionery material may be a chewing gum. Although the present disclosure is directed to confectionery materials, apparatus 10 may be used to form other extrudable center-filled items such as other extrudable foods (i.e., starches, pastas) as well as center-filled polymeric materials and products.

Pre-extruder 12 extrudes continuous confectionery extrudate 14 onto conveyor 16 for delivery to extruder 50. Confectionery extrudate 14 may have any shape or geometric form as desired including such nonlimiting examples as a rope, a sheet, a slab, or a strand with any desired thickness as is commonly known in the art. In an embodiment, confectionery extrudate 14 may have a rectangular or square cross-sectional shape. In an embodiment, pre-extruder 12 may be configured with a feedback system 18 for the formation of a continuous confectionery extrudate having a substantially uniform diameter, width, height, weight, and/or thickness along the entire length thereof. In other words, feedback system 18 may be used to monitor a property of the extrudate and adjust the extrusion parameters in order to form a continuous extrudate uniform in diameter, height, width, mass, weight, and/or volume along substantially the entire length of the continuous extrudate.

In an embodiment, feedback system 18 may include an extrudate flow regulator 20, a sensor device 22, and a controller 24 that places extrudate flow regulator 20 into operative communication with sensor device 22. Sensor device 22 may be placed anywhere downstream of the pre-extruder exit port and may be configured or otherwise positioned to detect a property of confectionery extrudate 14. Nonlimiting examples of suitable devices that may be used as sensor device 22 include one or more pairs of light emitter/receiver, a flowmeter, a weighing device, and combinations thereof. In an embodiment, a light emitter/receiver may be used to detect the diameter of confectionery extrudate 14. In a further embodiment, one or more emitter/receivers may be used in one or more planes for detection of the extrudate diameter as desired. In an embodiment, the light emitter/receiver may be a laser light emitter/receiver pair as is commonly known in the art. In a further embodiment, the light emitter/receiver may detect variance in the extrudate diameter as fine as about ±1 mm, or about ±0.1 mm, or about ±100 microns, or about ±10 microns or about ±2 microns, or about ±1 micron. Thus, sensor device 22 may be used to detect fine variations of a given property of confectionery extrudate 14.

In an embodiment, sensor device 22 may include a flow meter that detects the flow rate of confectionery extrudate 14. The flow meter may be placed directly at exit port 20 or adjacent to the exit port. The flow meter may provide precise flow rate detection on the order of about ±0.01 mm/second.

In an embodiment, sensor device 22 may also include a weighing device, such as a scale for example, to weigh a segment of confectionery extrudate 14. The weighing device may be a stand-alone device or may operate in conjunction with conveyor 16. The weighing device may be configured to detect very small variations in weight of a segment of confectionery extrudate 14. For example, the weighing device may detect weight variance as small as about ±0.01 mg. Thus, sensor device 22 may be configured to detect any desired property of the extrudate including nonlimiting examples such as the extrudate diameter, the weight of a segment of the extrudate, and any combination thereof.

In an embodiment, sensor device 22 senses or otherwise detects a property of confectionery extrudate 14 and directs an adjustment of the extrusion flow in response to the detected property. This feedback may be performed in order to provide a continuous extrudate with a uniform diameter along substantially the entire length thereof. Sensor device may send a detection signal to a controller 24 based on the detected property. Controller 24 may be in operative communication with a drive mechanism (such as a servo motor, for example) to move extrudate flow regulator 20 in order to increase or decrease the extrudate flow in response to the detection signal. Controller 24 may be any controlling device commonly known in the art such as a programmable logic controller or similar device, for example. Operative communication between controller 24, sensor device 22, and optionally conveyor 16 may be by way of such nonlimiting examples as electrical connection, mechanical connection, Internet connection, Bluetooth connection, RF frequency connection, optical connection, IR connection and the like.

Confectionery extrudate 14 may be received by extruder 50. Extruder (or co-extruder) 50 includes outer passageway 52, inner passageway 54 and exit port 56. Inner passageway 54 is concentrically disposed within outer passageway 52, passageways 52 and 54 extending to common exit port 56. Extruder 50 receives extrudate 14 in outer passageway 52 to form a pliable hollow rope or strand into which center fill material 58 may be introduced by way of inner passageway 54.

Inner passageway 54 may be in communication with a source 59 of a flowable center-fill or fill material 58 as is commonly known in the art. Fill material 58 may be a flowable solid material (i.e., a granular or powder material), a fluid confectionery material, a liquid, a gel, a paste and combinations thereof. Similar to confectionery extrudate 14, fill material 58 may be any hard candy, soft candy, chewing gum, or other confectionery substance, or compound that has a fluid phase, may take a fluid form, or may be flowable. Indeed, confectionery extrudate 14 and fill material 58 may be the same or different material. Center-fill material 58 may be heated, melted, dissolved, form a syrup, or become flowable or fluid as is commonly known in the art. Consequently, flowable confectionery material 58 may be a liquid, a syrup, a gel, a paste, or a flowable solid such as a granular solid or a confectionery in powder form at ambient conditions. In an embodiment, fill material 58 may be a liquid with a viscosity that may be adjusted as desired. The liquid may be further sweetened, flavored, and/or colored as desired.

In an embodiment, extruder 50 may coextrude confectionery extrudate 14 through outer passageway 52 and center-fill material 58 through inner passageway 54 and out through exit port 56 to form a continuous strand 60 of center-filled confectionery which may be received by a transport device such as a conveyor or transport rollers as is commonly known in the art. The outer portion 64 of strand 60 may be composed of the material of confectionery extrudate 14 whereas center-fill portion 66 of strand 60 may be composed of fill material 58.

In an embodiment, strand 60 may be uniform or highly uniform with respect to height, width, diameter, mass, weight and/or volume (i.e., very low variance in terms of mass, weight, area) along its length. In a further embodiment, extruder 50 may be configured with a feedback system 68 that detects a property of strand 60 and adjusts the flow rate of extrudate 14 and/or fill material 58 in response to the detected property. Feedback system 68 may include one or more flow regulation devices such as flow regulators 70a and 70b, a sensor device 72, and a controller 74 that places flow regulators 70a, 70b and detection device 72 in operative communication with each other. Flow regulator 70a may be used to adjust the flow of a confectionery, or a confectionery material, such as extrudate 14 from extruder 50. The flow regulator 70a restricts or increases the amount extrudate 14 entering the extruder 50 at the extruder inlet as shown in FIG. 1. In other words, the flow regulator 70 adjusts the flow rate of the confectionery entering the extruder 50 based on the detected property by sensor device 72.

In an embodiment, the extruder 50 has an extruder screw which moves the extrudate 14 from an inlet end of the extruder 50 to the exit port 56. The flow regulator 70a may be a drive device which adjusts the rotation rate of the extruder screw based on the detected property. For example, if the sensor device 72 detects that the confectionery is less than a desired diameter, the rotation rate of the extrusion screw may be increased. Alternatively, if the sensor device 72 detects that the confectionery weighs more than a predetermined amount or more than a desired amount, the flow regulator 70a may decrease the rotation rate of the extrusion screw.

In an embodiment, flow regulator 70b may be used to regulate the flow of fill material 58. In an embodiment, flow regulator 70b may be a pump or the like. Sensor device 72 may be positioned downstream of exit port 56. Feedback system 68 may operate in the same manner as feedback system 18 discussed above. For example, sensor device 72 may be a light emitter/receiver, a weighing device, and/or a flowmeter to detect a strand property such as the diameter (including height and width) of the strand, the weight of the strand, the volume of the strand, the flow rate of the strand, the flow rate of the outer fluid confectionery, and/or the flow rate of the inner center-fill material, and combinations thereof.

In an embodiment, sensor device 72 may be a flowmeter and may be attached to or may be directly adjacent to exit port 56. Sensor device 72 for extruder may include a flow meter that detects the flow of outer portion 64 (i.e., extrudate 14) and/or the flow of inner portion 66 (i.e., fill material 58). The flow meter may be placed directly at exit port 20 or adjacent to the exit port. The flow meter may provide a precise flow rate for extrudate in outer passageway 52 and/or the fill material in inner passageway 54. In an embodiment, sensor device 72 may accurately detect the flow rate of either the outer or inner portion within a tolerance of about ±0.01 mm/second.

In yet a further embodiment, controller 74 may be operatively connected to controller 24 thereby permitting further increased control of center-filled strand 60 formation. The flow rate of pre-extruder 12 may be coordinated with the flow rate of extruder 50 to provide a continuous strand of center-filled confectionery with little or no variation in weight, volume and/or dimension along substantially the entire length of the continuous strand.

Strand 60 may be transported by way of a transport device such as a conveyor or rollers through sizing rollers 76, 78 to reduce the diameter of the strand as shown in FIGS. 1-3. Nonlimiting examples of suitable transport devices include a conveyor and one or more transport rollers. In an embodiment, the tension applied to strand 60 by rollers 76, 78 alone or in combination with the transfer device may move or otherwise pull the strand from extruder 50. The number of sizing rollers may be varied as desired to obtain any desired diameter, width, or thickness for strand 60. It is understood that the sized strand (i.e., strand 60 after departure from the sizing rollers) may be substantially uniform in diameter, volume, mass, and weight along substantially the entire length thereof—similar to the uniformity of the strand prior to being subjected to the sizing rollers.

From extruder 50, strand 60 proceeds to forming device 200 as shown in FIG. 1. The strand 60 may be any flexible structure including such nonlimiting examples as a confectionery or a center-filled confectionery. Continuous strand 60 may be moved from rollers 76, 78 by way of a transport device as is commonly known in the art. Strand 60 passes by cutting device 100 which is located at a proximate end of forming device 200 and continues to proceed to a distal end of forming device 200. A detection device 202 located at a distal end of forming device 200 detects the arrival of a leading end 62 of strand 60 to the distal end of forming device 200. Detection device 202 may be any detection device capable detecting the presence/absence of leading end 62 as is commonly known in the art. Nonlimiting examples of suitable detection devices include optical, laser, and/or infrared detection devices. In an embodiment, detection device 202 may be an optical emitter/receiver pair, the emitter positioned on a first side of the travel path for continuous strand 60 and the receiver on an opposing second side of the travel path. Detection may occur when leading end 62 crosses, disrupts, impedes or otherwise breaks reception of an optical signal emitted by the emitter to be received by the receiver.

A controller 204 may be in operative communication with detection device 202 and cutting device 100 and/or the transport device. Alternatively, detection device 202 may be in direct operative communication with cutting device 100. Upon detection of leading edge 62, detection device 202 may generate and send a signal to controller 204. Controller 204 may then direct cutting device to cut continuous strand 60 thereby producing a center-filled confectionery segment. In an embodiment, controller 204 may coordinate operation of detection device 202, cutting device 100, and the transport device. For example, controller 204 may halt the operation of the transport device upon detection of leading end 62. Once the transport device has stopped the movement of the strand, controller 204 may direct cutting device 100 to initiate the cutting of continuous strand 60. Consequently, strand 60 may be cut when in a stationery or non-moving position.

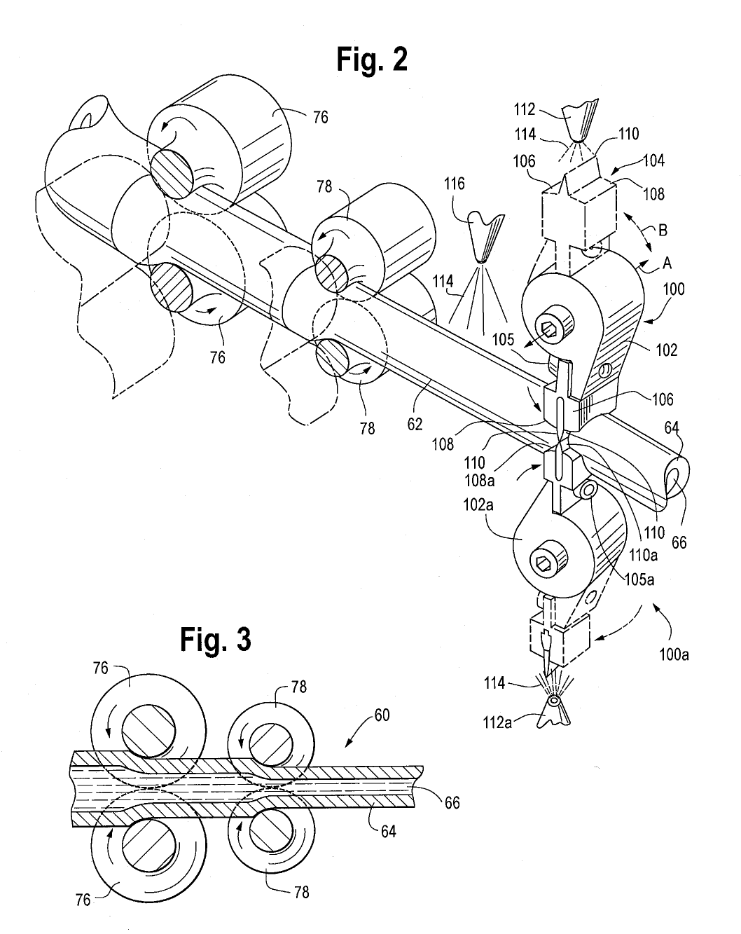

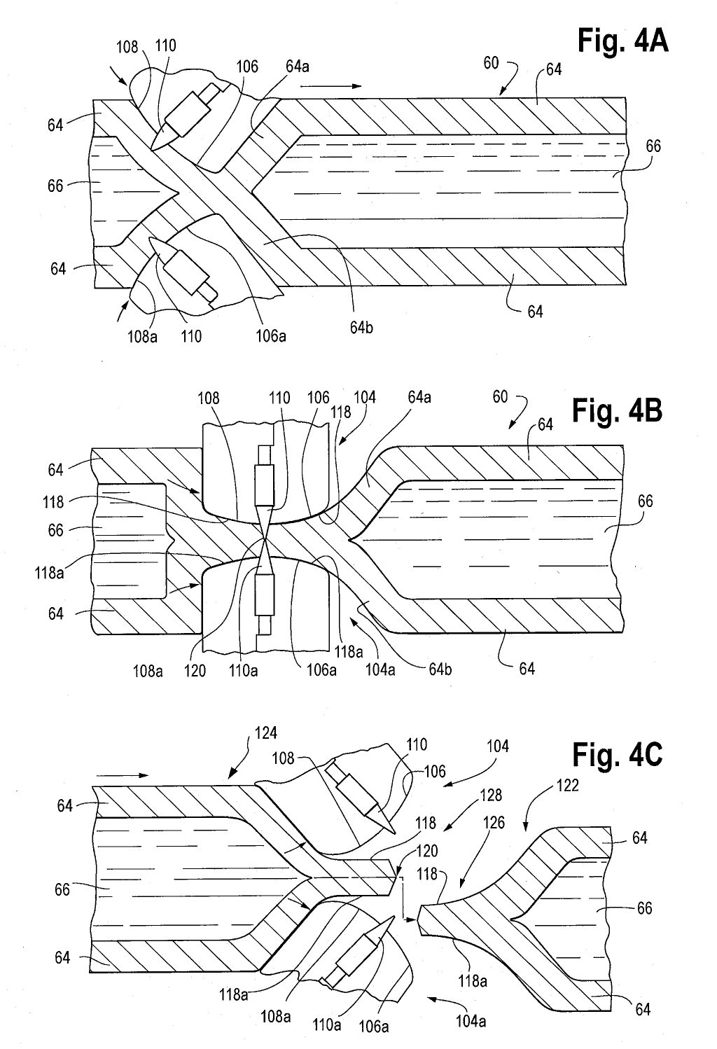

Turning to FIGS. 2 and 4A-4C, cutting device 100 includes a rotating member 102, a contact portion 104, first and second contact surfaces 106, 108, and a cutting edge 110. Rotating member 102 may be located adjacent to the travel pathway of continuous strand 60 and may be substantially cylindrical in shape. Contact portion 104 may be readily replaced/serviced by manipulation of screw 105. A drive mechanism (not shown) may rotate rotating member 102 about an axis A, rotating contact portion 104 as indicated by arrow B to engage the contact portion with strand 60. The drive mechanism may be in operative communication with controller 204 and/or detection device 202. Although FIG. 2 shows rotating member 102 disposed above strand 60, it is understood that rotating member 102 may be disposed along side of or below strand 60. In an embodiment, rotating member 102 may be located above continuous strand 60 and may be movable between an idle position (shown in phantom in FIG. 2) and a cutting position. In the idle position, contact portion 104 is not in contact with strand 60. In a further embodiment, a dispenser 112 may apply or spray an adhesion reducer 114 to contact portion 104 when rotating member 102 is in the idle position. Adhesion reducer 114 may be applied prior to the rotation of rotating member 102 to the cutting position. Nonlimiting examples of suitable adhesion reducers include oil, food grade oil, talc, calcium carbonate, a powder polyol, and combinations thereof. Nonlimiting examples of suitable powder polyols include maltitol, sorbitol, erythritol, mannitol, isomalt, lactitol, and xylitol. In an embodiment, the adhesion reducer may be a food grade oil. In yet a further embodiment, the cutting device 100 may include dispenser 116 that may apply adhesion reducer to a surface of strand 60 upstream of rotating member 102. It is understood that cutting device 100 may include one or both dispensers 112, 116.

In a further embodiment, cutting device 100a includes a first rotating member 102 (with associated components as previously described) and a second rotating member 102a having a contact portion 104a, first and second contact surfaces 106a, 108a, and a cutting edge 110a substantially similar to the components of cutting device 100 as previously described. Rotating member 102a may be placed at an opposing side of the strand pathway as rotating member 102. Rotating member 102a may be movable between an idle position and a cutting position as shown in FIG. 2. A dispenser 112a may apply an adhesion reducer 114 to contact portion 104a in the idle position as previously discussed. A cutting device having a single rotating member and associated components is embraced within the scope of this disclosure.

FIGS. 4A, 4B, and 4C illustrate the cutting process performed by cutting device 100a. Although the cutting process will be described in terms of cutting device 100, it is understood that this description may apply equally to cutting device 100a (i.e., the opposedly cooperating rotating member embodiment). Rotating member 102 moves first contact surface 106 into contact with the surface of strand 60 as shown in FIG. 4A. The area where contact portion 104 contacts strand 60 may be considered a contact area. Upon contact, first contact surface 106 applies a force or pressure to strand 60 which correspondingly forces, pushes or removes fill portion 66 away from the contact area. Continued rotation of rotary member 102 further flattens strand 60 at the contact area to form a strand flat portion 118. The gradual or incremental pressure applied by first contact surface 106 advantageously yields a flat portion 118 that is substantially free of center fill material 66. In other words, flat portion 118 may be considered an area or portion of strand 60 whereby outer portions 64a and 64b are placed into direct contact with each other so that flat portion 118 is composed solely of the outer portion of confectionery material 14. Stated differently, flat portion 118 is void or substantially void of fill material 66.

Further rotation of rotating member 102 brings cutting edge 110 into engagement with strand 60 at flat portion 118 as shown in FIG. 4B. As cutting edge 110 engages strand 60, second contact surface 108 also comes into contact with strand 60 to extend the length of flat portion 118. Second contact surface 108 applies a force onto strand 60 to push center-fill material 66 out of the extending length of flat portion 118. Cutting edge 110 subsequently produces a cut 120 in strand 60 thereby yielding a first center-filled confectionery segment 122 and a second center-filled confectionery segment 124 as shown in FIG. 4C. Cut 120 produces a sealed, crimped or flattened trailing end 126 on first center-filled confectionery segment 122. In an embodiment, cutting edges 110 and 110a may cooperate to cut or perforate strand 60 at flat portion 118 thereby to form cut 120.

Further rotation of rotary member 102 brings second contact surface 108 into continued contact with strand 60. In conjunction with the formation of cut 120, contact surface 108 seals and flattens leading end 128 of second center-filled confectionery segment 124. In an embodiment, cutting edge 110 forms cut 120 in the center of flat portion 118. The contact between first contact surface 106 and strand 60 corresponds to the flat or crimped trailing end 126 of first segment 122. Similarly, the contact between second contact surface 108 and strand 60 corresponds to the crimped/flat leading edge 128 of second segment 124.

The advantages of cutting device 100 and/or 100a are numerous. First, cutting device 100, 100a enables the continuous production of sealed center-filled confectionery segments with crimped or flattened leading and trailing ends. The flattened or crimped ends of the segments may be substantially free of center-fill material. This is beneficial as the center-fill material is typically sticky or highly adhesive and the elimination of the fill material from the segment ends reduces or eliminates the risk of fill material coming into contact with apparatus component surfaces and contributes to the efficient, economical and clean operation of apparatus 10.

Second, provision of the cutting edge 110 between the first and second contact surfaces 106, 108 ensures that cut 120 is formed in flat portion 118. Producing the cut in the flat portion contributes to the formation of sealed segment ends that exhibit little or no exposed center fill material.

Third, the flattening effect resulting from the contact between first and second contact surfaces 106, 108 and strand 60 moves the fill material in two different directions and eventually into to two different center-filled confectionery segments. This advantageously results in an even distribution of pressure upon the strand and an even distribution of center-fill material into the formant confectionery segments. Thus, cutting device 100 and contact portion 104 in particular promotes the provision of the uniform properties (e.g., diameter, mass, weight, volume, etc.) between the center-filled confectionery segments continuously formed by cutting device 100.

The cutting procedure may be initiated by direction from controller 204 or detection device 202. In an embodiment, continuous strand 60 may be stationary when cut 120 is formed. In a further embodiment, controller 204 may direct dispenser 112, 116 to apply adhesion reducer 114 onto contact portion 104 or onto a surface of strand 60 immediately prior to rotation of rotary member 102 to the contact position. This advantageously promotes non-adhesion between contact portion 104 and strand 60 and a clean cut 120. In other words, cutting device 100 produces continuous center-filled confectionery segments that are substantially uniform with respect to length, width, height, mass, weight, and/or volume.

Center-filled confectionery segment 122 may then be proceed to forming device 200. The forming device may be any device capable of forming a confectionery piece from a confectionery material or a sealed center-filled confectionery product from a strand of center-filled confectionery as is commonly known in the art. Nonlimiting examples of suitable forming devices include a rotoplast forming device, a chain drive forming device, a drum drive forming device, a pair of parallel rollers, and any combination thereof.

In an embodiment, forming device 200 includes first and second elongated rollers 206, 208 that are parallel to and opposed to each other as shown in FIG. 1. In other words, rollers 206, 208 are parallel and are positioned to cooperatively operate with each other. Each roller 206, 208 has radially protruding edges 210 spaced apart along the length each roller. Edges (or cutting edges) 210 extend radially outward and are arranged to cooperatively operate with the edges of the other roller. In particular, each edge 210 on first roller 206 has a mated edge 210 on second roller 208. The distance interval C between adjacent edges on first roller 206 is the same as the distance interval D between adjacent edges 210 on second roller 208 to ensure that the edges operate in a mated, cooperative manner. In an embodiment, intervals C and D have a length from about 10 mm to about 25 mm, or about 12 mm to about 15 mm, or about 15 mm.

Each roller has a proximate end 212 and a distal end 214. Proximate and distal roller ends 212 and 214 respectively correspond to the proximate and distal ends of forming device 200. An endmost edge is disposed at each roller end. For example, proximate endmost edges 216 are located at proximate end 212 and distal endmost edges 218 is located at distal end 214 as shown in FIG. 1.

Center-filled confectionery segment 122 may be disposed in parallel relation to rollers 206, 208. Segment 122 may then proceed through forming device 200 by passing between rollers 206, 208. In an embodiment, center-filled confectionery segment 122 may be formed adjacent to and above forming device 200 and may be lowered or gently dropped by way of gravity onto protruding edges 210, 216, and 218 and indicated by arrows E of FIG. 1. In a further embodiment, an adhesion reducer may be applied to the exterior surface of segment 122 prior to and/or during passage through forming device 200.

The distance between each edge pair is less than the width of center-filled confectionery segment 122. Consequently, cooperating edge pairs 210, 216, 218 catch and cooperatively engage center-filled confectionery segment 122. In an embodiment, rollers 206 and 208 are rotated about each respective longitudinal axis in contrary directions to feed or otherwise pass confectionery segment 122 through the rollers. For example, first roller 206 may be rotated in a first direction as indicated by arrow F and second roller 208 may be rotated in a second counter direction G as shown in FIG. 1. In a further embodiment, one roller, first roller 206 for example, may be movable toward and away from second roller 208. As center-filled confectionery segment 122 comes into contact with the top of edges 210, 216, and 218, rollers 206, 208 may rotate while first roller 206 simultaneously moves toward second roller 208. The rotation of rollers 206, 208 in conjunction with the gradual urging of first roller 206 toward second roller 208 feeds segment 122 through the gap between the rollers. Concomitantly, edge pairs 210, 216, 218 cooperatively engage segment 122 and gently pinch and eventually cut the segment into discrete confectionery pieces with the gradual urging of first rotating roller 206 toward second rotating roller 208. As center-filled confectionery segment 122 passes between the edges and the rollers, the center-filled portion of segment 122 swells or otherwise bulges radially outward causing the outer portion 64 to contact shaping surface 217—an arcuate surface that extends between adjacent edges along each respective roller. In an embodiment, a compressible fluid such as air or other gas may be injected into strand 60 to absorb the fluid forces imposed upon the segment interior during piece formation. In an embodiment, forming device produces from about 25 to about 35, or about 30 (32 including endmost pieces) spheroidally shaped sealed center-filled confectionery pieces 232 from segment 122.

Proximate endmost edges 216 may cooperatively engage segment 122 from opposing sides upon initial contact therewith. As center-filled confectionery segment 122 continues to pass between rollers 206, 208 proximate endmost edges 214 may cooperatively engage the segment as first roller 206 is gradually urged toward second roller 208 in order to pinch and cut center-filled confectionery segment 122 and form center-filled endmost confectionery piece 220. Endmost confectionery piece 220 is a sealed center-filled confectionery piece. In an embodiment, piece 220 includes a sealed end 222 that corresponds to a seal segment end (i.e., leading end or trailing end) and a sealed end 224 formed by endmost edges 216. In a further embodiment, distal endmost edges 218 may cooperatively engage segment 122 to form a sealed center-filled distal endmost confectionery piece 226. Piece 226 may include a sealed end 228 that corresponds to a segment end and an end 230 formed by endmost edges 218.

Edges 210 on first roller 206 cooperate with edges 210 on second roller 208 to engage segment 122 to pinch, cut, and form a plurality of sealed center-filled pieces 232 as segment 122 parallelly passes between rollers 206, 208. As center-filled confectionery segment 122 passes between the edges and the rollers, the center-filled portion of segment 122 swells or otherwise bulges radially outward causing the outer portion 64 to contact shaping surface 217—an arcuate surface that extends between adjacent edges along each respective roller. Contact between outer portion 64 and surface 217 forms the segment into a plurality of sealed pieces having a substantially spheroidal shape. Each individual piece 232 includes sealed ends formed by edges 210.

Forming device 200 carries several advantages over conventional forming devices. First, each confectionery piece formed by forming device 200 is a sealed, center-filled confectionery piece. For example, endmost pieces 220, 226 as well as pieces 232 are each sealed center-filled confectionery pieces. In an embodiment, no sealed center-filled confectionery piece has any center-fill material on an exterior surface. Moreover, no center-filled confectionery piece 220, 226, 232 has any exposed or visible center-fill material. In a further embodiment, each center-filled confectionery piece 220, 226 and 232 is leak-free, substantially leak-free, or otherwise leak resistant, or substantially leak resistant. As used herein, the term “leak-free” or “leak resistant” is the avoidance, absence or omission of center-fill material, flowing, exuding, seeping, oozing, dripping, draining, and/or pouring, from the center of the confectionery piece onto an outer surface of the piece or other piece and/or onto an adjacent surface. Stated differently, a “leak-free” or a “leak resistant” piece is a sealed center-filled confectionery piece wherein the fill material (i.e., center free material 66) is wholly enclosed within the outer confectionery substrate (i.e., outer portion 64).

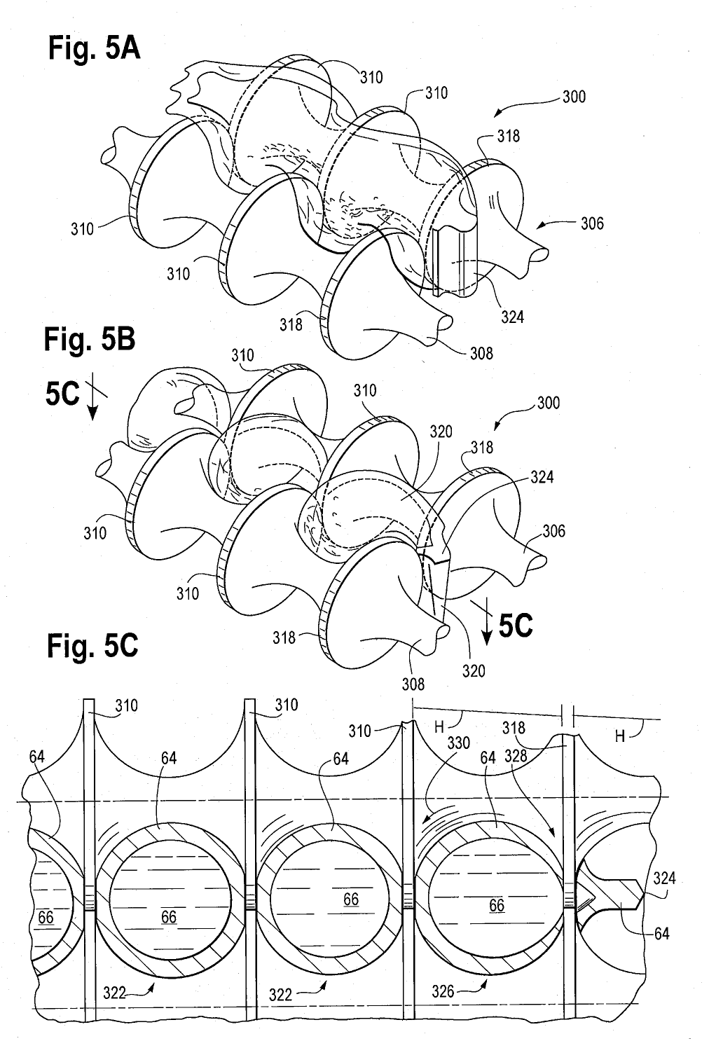

The advantages of forming device 200 may be more fully appreciated by comparing the present forming device to a conventional forming device. FIGS. 5A-5C depict a conventional forming device 300 having cooperatively opposing parallel rollers 306, 308 and radially protruding edges 310. Each roller 306, 308 also includes distal endmost edges 318. Protruding edges 310 of roller 306 cooperate with edges 310 of roller 308 to engage, pinch and cut center-filled confectionery segment 320 to form sealed center-filled confectionery pieces 322.

Forming device 300, however, does not form sealed center-filled endmost pieces. The alignment between center-filled confectionery segment 320 and rollers 306, 308 varies to such a degree in conventional forming devices that the length of endmost segment portion 324 is not sufficient to hold a seal when pinched and cut by outermost edge 318. Although not wishing to be bound by any particular theory, it is believed leaking center-filled confectionery endmost pieces (or “leakers”) are the result of at least two factors in conventional systems. First, the length of center-filled confectionery segment 320 in conventional systems varies to such a degree that when segment 320 passes between forming rollers 306, 308, endmost segment portion 324 includes an insufficient amount of outer confectionery material to form the pinch and cut seal.

Second, the position of endmost edge 318 inherently contributes to the formation of leakers as it fails to accommodate center-filled confectionery segment length variance. Segment length variance manifests itself at the endmost portions of the segment and correspondingly at the endmost portions of the rollers. Conventional forming devices maintain a distance interval H (the spaced apart distance between adjacent edges 310) between each edge—including the distance between endmost edge 318 and the end of the roller as seen in FIG. 5C. Consequently, any misalignment and/or segment length variance that results in the endmost segment portion having a length less than H will result in an endmost leaker.

In addition, it has been found that uneven pressure application by the edges also contributes to the formation of leakers. In particular, the occurrence of an endmost leaker impacts edge pressure distribution onto the segment and also contributes to a high percentage of penultimate leakers. As seen in FIG. 5C, when the length of endmost segment portion 324 is less than the length of penultimate segment portion 326, the pressure imparted by endmost edges 318 onto center-filled confectionery segment 320 is uneven with respect to the pressure applied by edges 310. Consequently, the pressure applied by endmost edge 318 onto outer side 328 of penultimate segment portion 326 is greater than the pressure imparted by edge 310 onto inner side 330 of the penultimate segment portion. The result of this unevenly applied pressure is a leak on outer side 328 of penultimate segment 326 as shown in FIG. 5C. Leakers are undesired as they are unacceptable product as the leaked center-fill material contacts and contaminates acceptable product pieces and leaked center-fill material contaminates apparatus components which results in equipment down-time and additional resources and cost for clean-up.

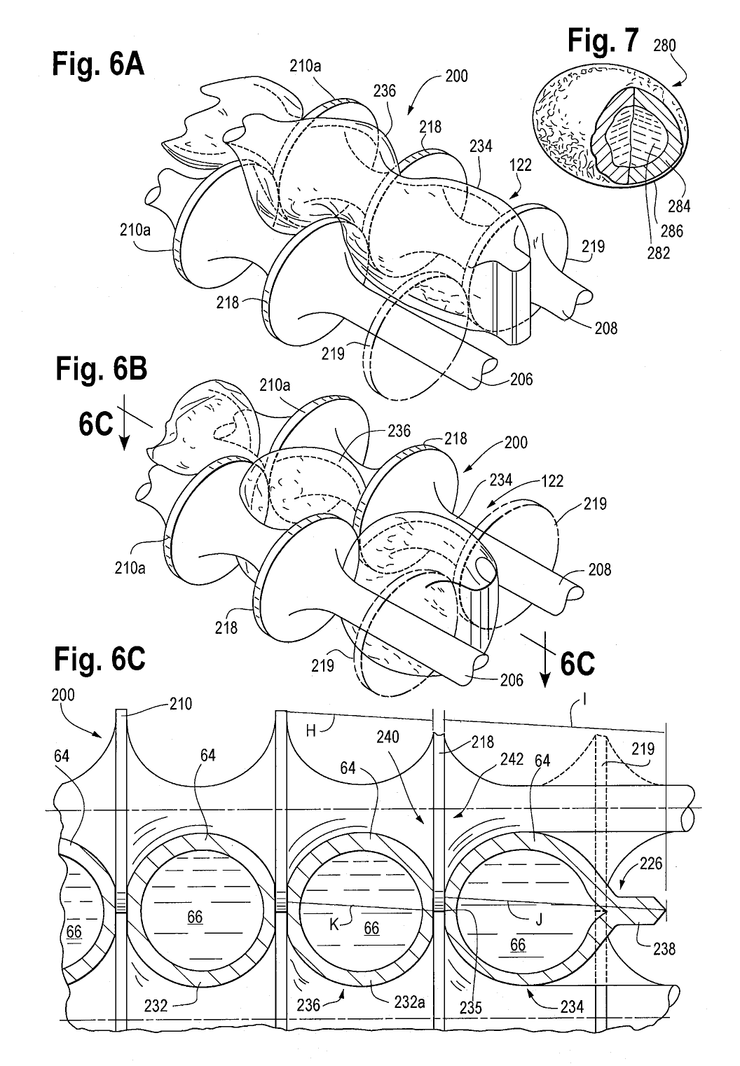

FIGS. 6A-6C further illustrate present forming device 200. First and second rollers 206, 208 include edges 210 and distal endmost edge 218. Initial endmost edges 219 (shown in phantom) have been removed from rollers 206, 208. Initial endmost edges 219 correspond to distal endmost edges 318 shown in FIGS. 5A-5C. Removal of initial endmost edge 219 advantageously enables rollers 206, 208 to form a sealed endmost piece regardless of variance in the length of the center-filled confectionery segment and/or variance in the alignment of the segment with respect to the rollers. Removal of initial endmost edges 219 creates interval I, the length between endmost edge 218 and the end of the rollers. Interval I is greater in length than interval H—the distance between adjacent edges 210 (FIGS. 6A-6C) and adjacent edges 310 (FIGS. 5A-5C). Interval H is a piece length. As used herein, “piece length” is the distance between protruding edges which is sufficient to permit the formation of sealed center-filled confectionery pieces when the center-fill confectionery strand passes between the rollers. Interval I is an end length. As used herein, the “end length” is the length between a protruding endmost edge and the end of the roller. Each roller 206, 208 has opposing ends. Consequently, each roller has a first end length and a second end length. In an embodiment, the first end length and the second end length are equal in length. Interval I provides for the formation of an endmost segment portion 234, endmost segment portion 234 having a length greater than endmost segment portion 324 of FIGS. 5A-5C. The increased length of endmost segment portion 234 provides an adequate amount of outer confectionery 64 to be extended, stretched, pinched, and cut in order to form a seal 235 around center-fill material 66. In addition, endmost segment portion 234 includes a sufficient amount or mass of outer confectionery material 64 to accommodate the uneven pressure that occurs as the result of the engagement of a single edge pair with the endmost segment portion.

Endmost edge 218 (or the omission of initial endmost edge 219) further contributes to the formation of penultimate segment portion 236 into a sealed center-filled confectionery penultimate piece 232a. The presence of endmost segment portion 234 (i.e., an endmost segment portion having sufficient mass to form a seal when passed between rollers 206, 208) substantially equalizes the pressure applied on segment 122 at inner and outer sides 240, 242 of endmost edges 218 when endmost edges 218 cooperatively engage segment 122. Correspondingly, the pressure applied on inner side 240 is substantially equal to the pressure applied by edges 210a onto segment 122. The equal pressure applied to the opposing sides of penultimate segment portion 236 enables the formation of sealed center-filled penultimate confectionery piece 232a.

In an embodiment, sealed endmost pieces 220, 226 may differ in size, weight, length, and/or diameter with respect to sealed pieces 232 formed along the inner portion of rollers 206, 208. As seen in FIG. 6C, the length J of endmost piece 226 is greater than the length K of piece 232. This is advantageous as the size differential between pieces 226 and pieces 232 permits ready segregation between endmost pieces and non-endmost pieces. The endmost pieces may also include a tail 238 providing additional differentiation from pieces 232. In an embodiment, a separating device 250 (FIG. 1) may be used to segregate or otherwise separate endmost pieces 220, 226 from pieces 232. Pieces 232 may proceed to a shaping device 260 (FIG. 1) which includes shaping rollers 262, 264, and 266. Pieces 232 may be placed on shaping roller 262, 264, 266 to round or otherwise shape generally spheroidal pieces 232 into a more rounded, curved, spherical, elliptical, or egg-shaped forms as desired.

Upon exit from shaping device 250, pieces 232 may be placed (either automatically or manually) on a transport device 270 and transported for further processing such as curing, coating (pan coating, for example), packaging and the like.

Finished sealed center-filled confectionery product 280, shown in FIG. 7, includes an inner fill portion 282 (which corresponds to center fill portion 66 and center fill material 58), an outer portion 284 (which corresponds to outer portion 64 and confectionery material 14) that substantially surrounds or otherwise wholly encases fill portion 282, and optionally a coating layer(s) 286. The product 280 may have a mass from about 3.5 g to about 15 g, or from about 6 g to about 9 g. In an embodiment, outer portion 284 may be a chewing gum and inner portion 282 may be a flavored syrup. The inner fill portion 282 may be present in an amount of 15-35% by weight of product 280, or from about 15% to about 25% by weight of the product 280, or from about 18% to about 22% by weight of the product 280. In a further embodiment, inner fill portion 282 may be greater than about 15% by weight, or greater than about 20% by weight, or greater than 25% by weight of product 280. The coating layer 286 may be from about 10-35% by weight of the product 280. Apparatus 10 thereby advantageously provides a center-filled confectionery product that includes more fill material than conventional center-filled confectionery products.

In an embodiment, the sealed center-filled confectionery product 280 is uncoated and has a mass from about 5.58 g to about 6.84 g, or any value therebetween, or about 6.3 g. The inner fill portion 282 has a mass from about 1.17 g to about 1.43 g, or any value therebetween, or about 1.3 g (or from about 20.8% to about 21.2% or about 21% by weight of the product). The outer portion 284 has a mass from about 4.41 g to about 5.31 g, or any value therebetween, or about 4.9 g (or from about 78.2% to about 79.8%, or about 79% by weight of the product).

In a further embodiment, the sealed center-filled confectionery product 280 is coated and has a mass from about 6.57 g to about 8.03 g, or any value therebetween, or about 7.3 g. The inner fill portion 282 has a mass from about 1.17 g to about 1.43 g, or any value therebetween, or about 1.3 g (or from about 17.7% to about 18.1% or about 17.9% by weight of the product). The outer portion 284 has a mass from about 4.41 g to about 5.31 g, or any value therebetween, or about 4.9 g (or from about 66.6% to about 68.0%, or about 67.3% by weight of the product. The coating layer 286 has a mass from about 0.9 g to about 1.2 g, or any value therebetween, or about 1.1 g (from about 14.6 to about 14.9%, or about 14.8% by weight of the coated product)

In an further embodiment, coating 286 may include any suitable coating material such as, for example, sugars, polyols, or combinations thereof to form a crystalline or glassy coating. The sugars or polyols may be, for example, a component of a syrup or spray that is applied to form the coating. Coating 286 may include a sweetener, a flavorant, a film forming agent, a colorant, a sensation producing ingredient, and combinations thereof. The sweetener for coating 286 may be sugar, sugar-based, or sugar-free. Non-limiting examples of suitable sweeteners include, maltitol, sorbitol, erythritol, mannitol, isomalt, lactitol, xylitol and combinations thereof. High intensity sweeteners may also be utilized in the coating portion. Coating 286 may be present in an amount of from about 10% to about 20% are about 15% by weight of confectionery product 280. Nonlimiting examples of suitable sensation producing ingredient may include a cooling agent, a food grade acid, a flavorant, and combinations thereof.

Apparatus 10 advantageously provides a system for substantially leak-free production of center-filled confectionery products having a large proportion of center fill material—i.e., a liquid center fill portion from about 15% to about 35% by weight of the product. Moreover, each and every center-filled piece formed by apparatus 10 is leak resistant. Apparatus 10 thereby substantially reduces and/or eliminates leakers from the production process. This increases production yields and reduces equipment downtime.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An apparatus for producing a confectionery product comprising:
an extruder for extruding a confectionery; and
a sensor device for detecting a property of the confectionery, the sensor device in operative communication with an extruder screw of the extruder, the sensor device causing an adjustment of a rotation rate of the extruder screw based on the detected property.

2. The apparatus of claim 1 wherein the adjustment produces a confectionery having a substantially uniform diameter along substantially an entire length thereof.

3. The apparatus of claim 1 wherein the sensor device is selected from the group consisting of a light emitter/receiver, a weighing device, a flowmeter and combinations thereof.

4. The apparatus of claim 1 wherein the property is selected from the group consisting of a diameter of the confectionery, a weight of the confectionery, a flow rate of the confectionery, and combinations thereof.

5. An apparatus for producing a confectionery product comprising:
an extruder for extruding a center-filled confectionery;
a sensor device for detecting a property of the center-filled confectionery, the sensor device in operative communication with a confectionery flow regulation device and a fill material flow regulation device, the extruder causing an adjustment of a flow rate based on the detected property, the flow rate selected from the group consisting of a confectionery flow rate, a center fill material flow rate, and combinations thereof.

6. The apparatus of claim 5 wherein the property is selected from the group consisting of a diameter of the center-filled confectionery, a weight of the center-filled confectionery, a flow rate of the center-filled confectionery, a flow rate of an outer confectionery material, a flow rate of a center fill material, and combinations thereof.

7. The apparatus of claim 5 wherein the center-filled confectionery has a substantially uniform diameter along substantially an entire length thereof.

8. The apparatus of claim 5 comprising a pre-extruder for delivering a confectionery extrudate to the extruder; and
a second sensor device for sensing a second property of the confectionery extrudate, the second sensor device in operative communication with the pre-extruder, the pre-extruder adjusting an extrusion flow rate in response to the detected second property.

10. The apparatus of claim 8 wherein the second sensor device is selected from the group consisting of a light emitter/receiver, a weighing device, a flowmeter, and combinations thereof.

11. The apparatus of claim 8 wherein the second property is selected from the group consisting of a diameter of the extrudate, a weight of the extrudate, a flow rate of the extrudate, and combinations thereof.

12. The apparatus of claim 5 comprising a forming device for forming a plurality of sealed center-filled confectionery pieces when the center-filled confectionery passes therethrough.

13. The apparatus of claim 13 wherein the forming device is selected from the group consisting of a rotoplast forming device, a chain drive forming device, a drum drive forming device, a pair of parallel rollers, and combinations thereof.

14. A method for producing a confectionery product comprising:
extruding a confectionery from an extruder having an extruder screw;
detecting a property of the confectionery; and
adjusting a rotation rate of the extrusion screw based on the detected property.

15. The method of claim 14 comprising forming a confectionery having a substantially uniform diameter along substantially an entire length thereof.

16. The method of claim 14 comprising detecting a property of the confectionery selected from the group consisting of a diameter of the confectionery, a weight of the confectionery, a flow rate of the confectionery, and combinations thereof.

17. A method for producing a confectionery product comprising:
extruding a center-filled confectionery;
detecting a property of the center-filled confectionery; and
adjusting a flow rate based on the detected property, the flow rate selected from the group consisting of a confectionery flow rate, a center fill material flow rate and combinations thereof.

18. The method of claim 17 comprising forming a center-filled confectionery having a substantially uniform diameter along substantially an entire length thereof.

19. The method of claim 17 comprising detecting a property selected from the group consisting of a diameter of the center-filled confectionery, a weight of the center-filled confectionery, a flow rate of the center-filled confectionery material, a flow rate of an outer confectionery material, a flow rate of a center-fill material, and combinations thereof.

20. The method of claim 17 comprising forming a plurality of sealed center-filled confectionery pieces from the center-filled confectionery.

21. The method of claim 20 comprising cutting the center-filled confectionery into a sealed center-filled confectionery segment before the forming.

22. The method of claim 17 comprising extruding a confectionery extrudate;
detecting a second property of the confectionery extrudate;
adjusting the extruding in response to the second property; and
forming with the confectionery extrudate an outer portion of the center-filled confectionery.

23. The method of claim 22 comprising forming a confectionery extrudate having a substantially uniform diameter along substantially an entire length thereof.

24. The method of claim 22 comprising detecting a property selected from the group consisting of a diameter of the confectionery extrudate, a weight of the confectionery extrudate, a flow rate of the confectionery extrudate, and combinations thereof.

25. A cutting device comprising:
a rotating member with a contact portion, the contact portion having a cutting edge located between a first contact surface and a second contact surface; and
wherein the rotating member being so constructed and arranged that when it is rotated the contact portion contacts a flexible structure to be cut, the contact portion producing a flat portion on the flexible structure, and the cutting edge cuts the flat portion.

26. The cutting device of claim 25 comprising a dispenser for applying an adhesion reducer to a member selected from the group consisting of the flexible structure, the contact portion, and combinations thereof.

27. The cutting device of claim 25 comprising a second rotating member having a second contact portion with a second cutting edge, the rotating member located on a first side of the flexible structure and the second rotating member located on an opposing second side of the flexible structure, the contact portions of each rotating member cooperatively contacting the flexible structure to cut the flexible structure on the flat portion.

28. The cutting device of claim 25 wherein the contact portion and the second contact portion form respective first and second flat portions on opposing sides of the flexible structure, the first and second flat portions being substantially coextensive.

29. A method of cutting a confectionery comprising:
moving a confectionery adjacent to a rotating member with a contact portion, the contact portion having a first contact surface and a second contact surface and a cutting edge therebetween;
contacting the confectionery with the contact portion to form a flat portion on the confectionery; and
cutting the flat portion with the cutting edge.

30. The method of claim 29 wherein the confectionery is a center-filled confectionery, the method comprising sealing at least one end of the center-filled confectionery and forming a sealed center-filled confectionery segment.

31. The method of claim 30 wherein the center-filled confectionery comprises a center-fill material, the method comprising removing the center-fill material from the at least one end prior to the sealing.

32. The method of claim 29 comprising contacting the first contact surface with the confectionery before the cutting.

33. The method of claim 29 comprising contacting the second contact surface with the confectionery after the cutting.

34. The method of claim 29 comprising feeding the confectionery between the rotating member and a second rotating member with a second contact portion and a second cutting edge;
rotating the rotating members to bring the first and second cutting edges in cooperative engagement with each other; and
cutting the confectionery from opposing sides.

35. The method of claim 34 comprising forming first and second flat portions on opposing sides of the confectionery.

36. A forming device for forming a confectionery product comprising:
a first rotatable roller parallel to a second rotatable roller, each roller having a plurality of spaced apart protruding edges with a piece length between each protruding edge, and an end length between a protruding endmost edge and an end of the rollers, the end length being greater than the piece length.

37. The forming device of claim 36 wherein each roller comprises a second end length between a second protruding endmost edge and a second end of the rollers, the second end length being greater than the piece length.

38. The forming device of claim 36 wherein the first roller is moveable towards and away from the second roller.

39. The forming device of claim 36 wherein the rollers further comprise an arcuate shaping surface between the protruding edges.

40. The forming device of claim 36 wherein the rollers are rotatable to cooperatively engage the protruding edges of the first roller with the protruding edges of the second roller to form a plurality of sealed center-filled confectionery pieces when a center-filled confectionery segment parallel to the rollers passes between the first and second rollers, the forming device comprising a separating device for separating a sealed center-filled confectionery piece having a piece length from a sealed center-filled confectionery piece having an end length.

41. The forming device of claim 40 comprising a shaping device for forming the sealed center-filled confectionery piece having the piece length into a shape selected from the group consisting of spheroidal, spherical, substantially spherical, elliptical, egg-shaped, and combinations thereof.

42. A method for producing a confectionery product comprising:
providing a first rotatable roller parallel to a second rotatable roller, each roller having a plurality of spaced apart protruding edges with a piece length between each protruding edge;
removing a protruding edge from an end of each roller to produce an end length between a protruding endmost edge and the end of each roller, the end length being greater than the piece length;
placing a sealed center-filled confectionery segment between the first and second rollers; and
rotating the rollers to cooperatively engage the protruding edges to form a sealed center filled confectionery piece having an end length and at least one sealed center filled confectionery piece having a piece length.

43. The method of claim 42 comprising forming the sealed center-filled confectionery piece having the piece length to contain from about 15% to about 25% by weight of a center-fill material.

44. The method of claim 42 comprising forming the sealed center-filled confectionery piece having the piece length to have a weight from about 6 g to about 9 g.

45. A method for producing a confectionery product comprising:
placing a sealed center-filled confectionery segment between a first roller that is parallel to a second roller, each roller having a protruding endmost edge;
rotating the rollers to cooperatively engage the protruding edges; and
forming with the protruding endmost edges a sealed center-filled confectionery endmost piece.

46. The method of claim 45 wherein the sealed center-filled confectionery segment has opposing ends, the method further comprising sealing the ends before the placing.

47. The method of claim 45 comprising moving the first roller toward the second roller during the forming.

48. The method of claim 45 wherein each roller includes a first protruding endmost edge at a first roller end and a second protruding endmost edge at a second roller end, the method comprising cooperatively engaging the first protruding endmost edges and the second protruding endmost edges and forming respective first and second sealed center-filled confectionery endmost pieces.

49. A method for forming a confectionery product comprising:
placing a sealed center-filled confectionery segment between a first roller that is parallel to a second roller, each roller having a protruding endmost edge spaced from a protruding inner edge;
rotating the rollers to cooperatively engage the protruding edges; and
forming a sealed center-filled confectionery endmost piece and a sealed center-filled confectionery piece, the sealed center-filled confectionery endmost piece having a length greater than the length of the sealed center-filled confectionery piece.

50. The method of claim 49 comprising separating the sealed center-filled endmost piece from the sealed center-filled confectionery piece and shaping the sealed center-filled confectionery piece into a shape selected from the group consisting of rounded, spherical, substantially spherical, elliptical, egg-shaped and combinations thereof.

51. The method of claim 49 comprising forming the sealed center-filled confectionery piece to contain from about 15% to about 25% by weight of a center-fill material.

52. The method of claim 49 comprising forming the sealed center-filled confectionery piece to have a weight from about 6 g to about 9 g.

53. The method of claim 49 comprising forming a leak-free sealed center-filled confectionery piece.

54. The method of claim 49 comprising forming a leak-free sealed center-filled confectionery endmost piece.

55. An apparatus for forming a confectionery product comprising:
a cutting device at a proximate end of a forming device and a detection device at a distal end of the forming device, the detection device in operative communication with the cutting device; and
the detection device directs the cutting device to cut a confectionery into a confectionery segment when the detection device detects the presence of a leading end of the confectionery.

56. The apparatus of claim 55 comprising a transport device for moving the center filled confectionery from the cutting device to the detection device.

57. The apparatus of claim 55 wherein the forming device receives the confectionery segment and forming a plurality of confectionery pieces.

58. The apparatus of claim 55 wherein the forming device comprises a pair of parallel rollers, the pair of parallel rollers having a plurality of cooperating protruding edges spaced apart along a length of the rollers.

59. The apparatus of claim 58 wherein the pair of parallel rollers has a distal end portion, and the leading end passes between the distal end portion.

60. The apparatus of claim 58 wherein the pair of rollers has a proximate end portion, and a trailing end of the sealed confectionery segment passes through the proximate end portion.

61. The apparatus of claim 56 comprising a controller in operative communication with the detection device, the cutting device and the transport device, the controller halting the transport device upon detection of the leading end.

62. The apparatus of claim 61 wherein the controller directs the cutting device to cut the strand after the transport device is halted.

63. A method for producing a confectionery product comprising:
moving a leading end of a confectionery to a distal end of a forming device;
detecting the presence of the leading end at the distal end; and
cutting the confectionery with a cutting device located at a proximate end of the forming device upon detection of the leading edge.

64. The method of claim 63 comprising halting the moving upon occurrence of the detecting.

65. The method of claim 64 wherein the cutting occurs after the halting.

66. The method of claim 63 wherein the confectionery is a center-filled confectionery, the method comprising forming a sealed center-filled confectionery segment;
placing the sealed center-filled confectionery segment into the forming device; and
forming a plurality of leak-free sealed center-filled confectionery pieces from the sealed center-filled confectionery segment.
